(19) United States
(12) Patent Application Publication
(10) Pub. No.: US 2026/0357614 A1
(43) Pub. Date: Nov. 12, 2026

(54) Spring Loaded Plug for Electronic Cam Lock

(71) Applicant: Security People, Inc., Houston, TX (US)

(72) Inventors: An Zhang, Shaoguan City (CN); Tevfik Asil Gokcebay, Petaluma, CA (US)

(21) Appl. No.: 19/203,977

(22) Filed: May 9, 2025

(51) Int. Cl. E05B 27/00

(52) U.S. Cl. CPC E05B 27/0007

(57) ABSTRACT

An adapter plug for retrofitting an electronic cam lock to a mechanical replaceable plug cam lock. The adapter plug includes a shell and a slider, where the slider is biased away from the shell by a spring to accommodate cylinders of varying lengths. A spline and groove mechanism allows translational movement between the shell and slider while preventing relative rotation. The shell receives a drive shaft from an electronic cam lock, and the slider engages a coupling within the mechanical lock cylinder. The design enables universal compatibility with various manufacturers' profiles and cylinder lengths.

### TECHNICAL FIELD

The disclosed plug relates to electronically operated furniture locks in general, and specifically to a spring loaded plug for converting a mechanical replaceable plug cam lock to an electronically operated cam lock.

### BACKGROUND OF THE INVENTION

Mechanically-operated cam locks are well known prior art locks useful for furniture such as desk drawers and file cabinets. The cam lock is disposed in the front face of the item of furniture, and a cam blade is disposed inside, typically behind the frame of the furniture piece, thereby locking the door or drawer in the closed position. The user simply inserts a key into a cylinder of the lock and rotates the cylinder. The cylinder is attached to the cam blade, and the rotation of the cylinder rotates the cam blade from behind the frame, such that the drawer or cabinet is released. These standard cam locks, however, take a significant amount of time to replace if, for example, the key is lost or broken.

To address the issue related to re-keying time, replaceable plug cam locks were developed. Examples of these cam locks can be seen in U.S. Pat. Nos. 4,866,964 and 5,101,649. A simplified version of a cam lock 8 is shown in FIGS. 1-6, and it includes a cylinder 10 having external threads 12. The cylinder 12 is mounted in a drawer front 14 via a nut 16 screwed on the threads 12. The cylinder 10 includes a hollow core 18 in which a coupling 20 is rotatably disposed. The cam blade 22 is attached to the coupling 20 by a fastener 24. The coupling 20 includes a connector 26.

Also shown in FIGS. 1-6 is a replaceable plug 28. The plug 28 may be inserted into the cylinder 10 and retained within the cylinder 10 by a retractable retaining pin 30. The plug 28 may include bits 32 that operate with a key 34 to lock and unlock the cam lock 8 as is well known. The plug 28 further includes a profile 36 that is complementary to and sits within the connector 26 of the coupling 20. Thus, when the user inserts the key 34 into the plug 28 and the bits 32 align, the user may rotate the plug 28 within the cylinder 10. The profile 36 is rotated, which causes rotation of the coupling 20 and the cam blade 22. To replace the plug 28 if the key is lost or broken, the retaining pin 30 is retracted by known means, and the plug 28 is simply pulled out of the cylinder 10. A new plug 28 may then be installed.

As is known in the art, different manufacturers use different profiles 36 that match up with different connectors 26 within the couplings 20. Thus, when ordering replacement plugs 28, one must know which manufacturer to order from. Moreover, for different applications, such as wood drawer fronts vs. metal drawer fronts, the cylinder 10 may be longer or shorter.

Accordingly, not only must the user specify the manufacturer of the lock, but they must also specify the length of the cylinder 10 as well.

To add further functionality to the cam lock, applicant developed an electronically operated cam lock, including a version for retrofitting to a replaceable plug cam lock, which is shown and described in Applicant's earlier U.S. Pat. No. 12,020,522, in particular in FIGS. 13 and 14. While the inventions described in the '522 patent were great advances, further refinement and functionality may be had.

### BRIEF DESCRIPTION OF THE DRAWINGS

FIG. 1 is a perspective view of a panel with a cylinder configured to receive a removable plug.

FIG. 2 is an elevation view of a removable plug distal from the cylinder of FIG. 1.

FIG. 3 is an elevation view of the removable plug and cylinder of FIG. 2 is section view.

FIG. 4 is a perspective view of removable plug mounted in the cylinder.

FIG. 5 is an elevation view of the removable plug mounted in the cylinder, with the panel is section view.

FIG. 6 is an elevation view of the removable plug mounted in the cylinder in section view.

FIGS. 7a and 7b are front and rear perspective views of prior art electronic cam lock housings.

FIG. 8 is a perspective view of the electronic cam lock of FIGS. 7a and 7b, the cylinder of FIGS. 1-6, and an adapter.

FIG. 9 is a front perspective view of an adjustable length adapter plug.

FIG. 10 is a rear perspective view of the adjustable length adapter plug of FIG. 9.

FIG. 11 is a front view of the adjustable length adapter plug of FIG. 9.

FIG. 12 is a side view of the adjustable length adapter plug of FIG. 9.

FIG. 13 is a rear view of the adjustable length adapter plug of FIG. 9.

FIG. 14 is a section view of the adjustable length adapter plug of FIG. 9 taken along line A-A in FIG. 11.

FIG. 15 is a section view of a second example of an adjustable length adapter plug.

### DETAILED DESCRIPTION

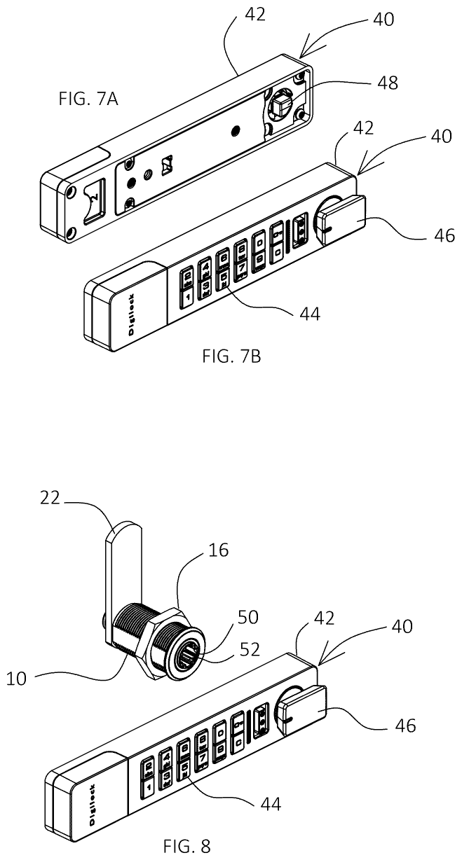

Referring now to FIGS. 7A, 7B, and 8, an electronic cam lock 40 is depicted which was previously disclosed in U.S. Pat. No. 9,631,399, and which is similar to the cam lock disclosed in FIGS. 13 and 14 of the '522 patent. The cam lock 40 includes a housing 42, a keypad 44, a knob 46, and a drive shaft 48 coupled to and opposite the knob 46. The cam lock 40 may have an internal locking mechanism as disclosed in Applicant's '399 Patent. In use, the user may input a predetermined unlocking code into the keypad 44, which results in a pin internal to the housing 42 being retracted from the drive shaft 48 and allowing the user to rotate the knob 46 and drive shaft 48. Although a keypad 44 is shown, the code input terminal could be any known terminal, such as RFID, Bluetooth, or NFC device, internet connection, biometric, and the like.

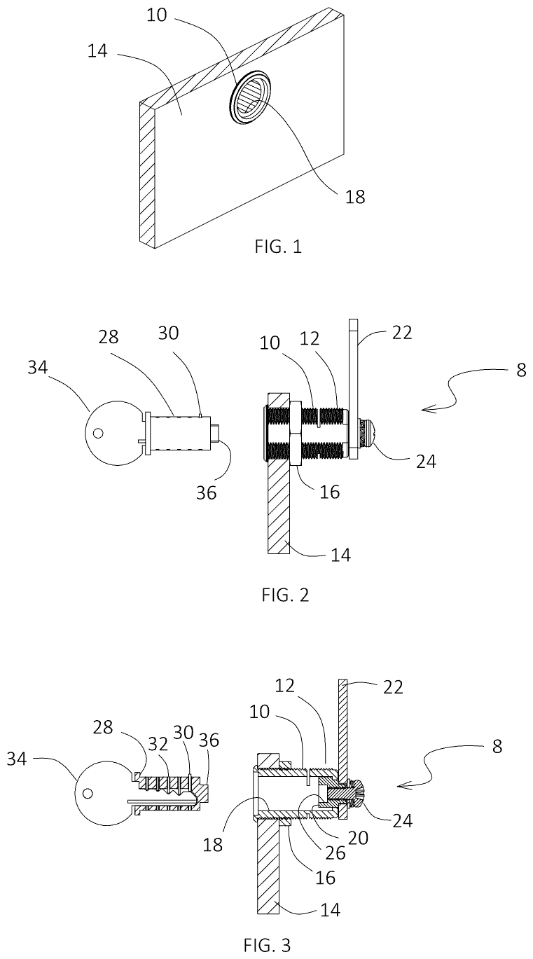

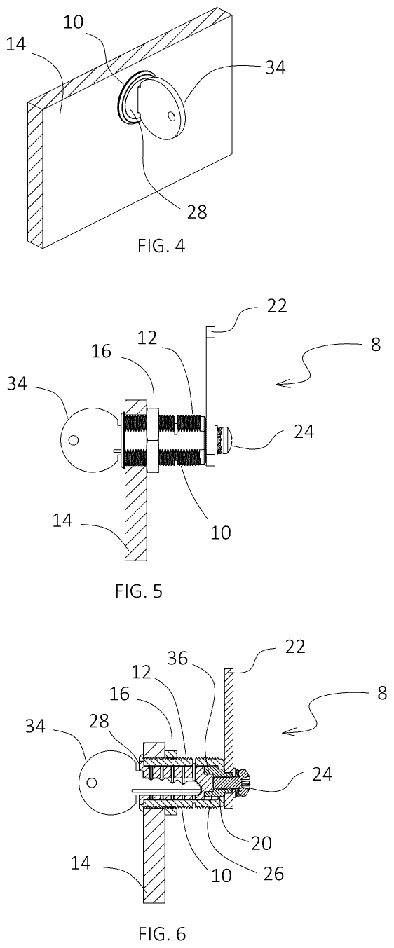

A cylinder 10, nut 16, and cam blade 22 are further disclosed in FIG. 8, similar to FIGS. 1-6 above. Further, an adapter plug 50 is rotatably disposed in the cylinder 10 and mates with the coupling (such as disclosed in FIGS. 3 and 6 above) inside the cylinder 10, such that rotation of the adapter plug 50 will cause rotation of the cam blade 22. The adapter plug 50 has an internal recess 52 sized and shaped to receive the drive shaft 48 such that rotation of the drive shaft 48 causes rotation of the adapter plug 50.

The adapter plug 50 allows for an electronic cam lock manufacturer to manufacture a single model of electronic lock 40, and the electronic lock 40 can be used to retrofit against any existing replaceable plug mechanical cam lock. Because manufacturers of replaceable plug cam locks use differently-shaped profiles and connectors to connect within the cylinder, the user can specify the replaceable plug lock manufacturer, and the end user can use the electronic lock 40 as well as a particular adapter plug 50 designed for that manufacturer, for any replaceable plug cam lock.

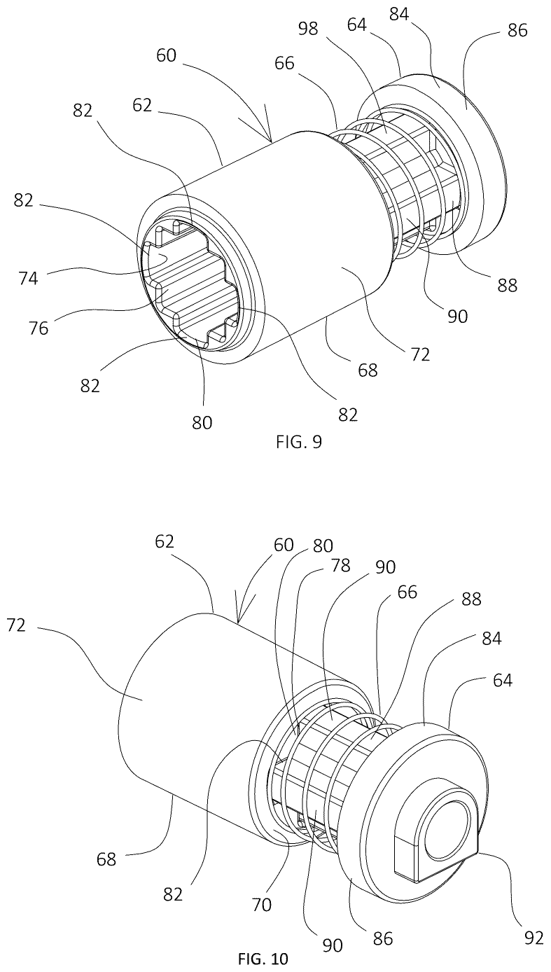

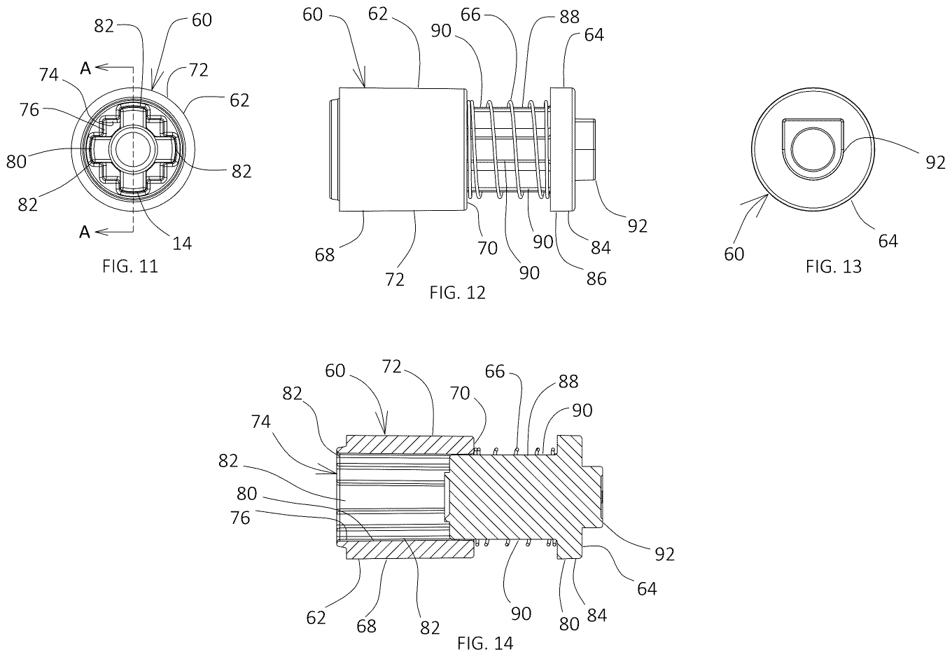

Referring now to FIGS. 9-14, detail views of the adjustable length replaceable adapter plug 60 are shown. The disclosed adapter plug 60 can adapt to various lengths of the cylinder 10, rendering the requirement to specific the exact length of the cylinder unnecessary, as the adapter plug 60 can accommodate multiple lengths of cylinder 10.

The adapter plug 60 includes a shell 62 and a slider 64 that is longitudinally slidable relative to the shell 62. The adapter plug 60 further includes a spring 66 that biases the shell 62 and the slider 64 apart from one another to increase the effective length of the plug 60. The shell 62 has a generally cylindrical portion 68 and an end wall 70. The cylindrical portion 68 has an outer surface 72 sized and shaped to rotate within the cylinder 10. The cylindrical portion 68 further includes an interior portion 74 defining, in part, a recess 76 that may be sized and shaped to receive the shaft 48 of the electronic lock 70. The end wall 70 includes an opening 78 defining a composite groove 80, and the composite groove 80 extends within the interior portion 74 of the cylindrical portion 68. The composite groove 80 includes individual grooves 82 that combine to form a cross shape.

The slider 64 includes a base wall 84 that is generally cylindrical in shape and has an outer surface 86 that may correspond to the outer surface 72 of the shell 62. The slider 64 includes a composite spline 88 extending away from the base wall 84 that is complementary to the composite groove 80 in the shell 68. The composite spline 88 includes four individual splines 90 which make up the cross shape. Accordingly, the slider 64 can slide axially relative to the shell 62, but the slider 64 and the shell 62 are fixed rotationally relative to one another. The slider 64 further includes a profile 92 disposed on a side of the base wall 84 opposite the composite spline 88. The profile 92 is as in prior art examples and functions to interact with the existing connector 26 in the existing coupling 20. While a cross-shaped composite spline and a corresponding composite groove is shown, other shapes of splines and grooves are known and can be employed.

In use, the user simply inserts the adapter plug 60 into a cylinder 10, then mounts the electronic lock 40 to the door, drawer front, or panel, with the shaft 48 inserted into the recess 76 of the shell 62. The spring 66 biases the shell 62 and the slider 64 apart, and the profile 92 engages the connector 26 of the coupling 20. The shell 62 and slider 64, being slidable relative to each other, can accommodate cylinders 10 of different lengths, while still engaging both the shaft 48 and the connector 26 of the coupling 20 at the same time. The adapter plug 60 transmits the rotational force applied to the knob 46 to the coupling 20 within the cylinder 10, thereby rotating the cam blade 22.

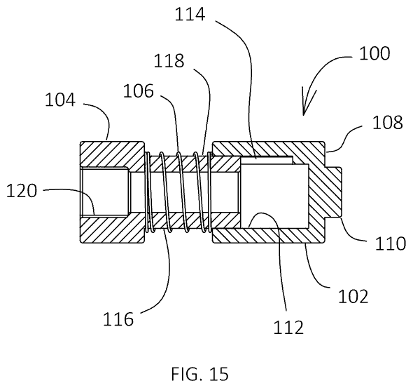

An alternative embodiment is depicted in FIG. 15, with similar functionality and geometry, but the elements are generally reversed. Here, the adapter plug 100 includes a shell 102 and a slider 104 and a spring 106 biasing the shell 102 away from the slider 104. The shell 102 includes an end wall 108 with the profile 110 extending off the end wall 108. The shell 102 further includes a recess 112 with one or more grooves 114. The slider 104 includes a shaft 116 with one or more splines 118 disposed thereon. The splines 118 are disposed in the grooves 114 which, again, allow translational movement between the shell 102 and slider 104, but prevent rotational movement between the two. Opposite the shaft 116 is a receiver 120 sized and shaped to receive the shaft 48 from the electronic cam lock 40. The spline 118 and the groove 114 could easily be reversed, with the groove 114 being disposed in the shaft 116, and the spline 118 being disposed within the recess 112 of the shell 102. The operation of this alternative embodiment is similar to the operation of the embodiment of FIGS. 9-14.

One skilled in the art will readily appreciate that the disclosed plugs are well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. An adapter plug for a cam lock, comprising:
a shell having a cylindrical portion and an end wall, the cylindrical portion including an interior portion, the interior portion including a recess sized and shaped to receive a drive shaft from an electronic cam lock, the interior portion further including a groove, the end wall including an opening corresponding to the groove;
a slider including a base wall and spline extending from the base wall, the spline disposed in the opening and sized and shaped to engage the groove, the slider further including a profile disposed on the base wall opposite the spline, the profile sized and shaped to engage a connector of a coupling; and
a spring disposed between the shell and the slider and configured to bias the slider away from the shell;
wherein the spline and groove cooperate to permit translational movement between the shell and the slider but prevent rotational movement between the shell and the slider.

2. The adapter plug of claim 1, the slider further comprising a plurality of splines, the shell further comprising a plurality of grooves, the end wall opening corresponding to the plurality of grooves.

3. The adapter plug of claim 1, the shell having a cylindrical outer surface.

4. The adapter plug of claim 3, the base wall having a cylindrical outer surface.

5. The adapter plug of claim 4, the cylindrical outer surface of the base wall corresponding to the cylindrical outer surface of the shell.

6. An adapter plug for a cam lock, comprising:
a shell having an end wall and a profile disposed on the end wall, the profile sized and shaped to engage a connector of a coupling, the shell further defining a cylindrical portion with a recess disposed therein;
a slider including a shaft disposed within the recess of the shell, the slider further including a receiver opposite the shaft and sized and shaped to receive a drive shaft from an electronic lock;
a spring disposed between the shell and the slider and configured to bias the slider away from the shell;
the shell further comprising one of a spline or a groove, the slider comprising the other of the spline or the groove, the spline and the groove cooperating to permit translational movement between the shell and the slider but prevent rotational movement between the shell and the slider.

7. The adapter plug of claim 6, further comprising a plurality of splines and grooves.

8. The adapter plug of claim 6, the shell having a cylindrical outer surface.

9. The adapter plug of claim 8, the slider having a cylindrical outer surface.

10. The adapter plug of claim 9, the cylindrical outer surface of the slider corresponding to the cylindrical outer surface of the shell.
